(19) United States
(12) Patent Application Publication
(10) Pub. No.: US 2013/0157213 A1
(43) Pub. Date: Jun. 20, 2013

(54) APPARATUS FOR ORTHODONTIC ALIGNER TRAY RETENTION

(71) Applicant: Airton Arruda, Ann Arbor, MI (US)

(72) Inventor: Airton Arruda, Ann Arbor, MI (US)

(21) Appl. No.: 13/327,469

(22) Filed: Dec. 15, 2011

(51) Int. Cl. A61C 7/08; A61C 7/36

(52) U.S. Cl. 433/6

(57) ABSTRACT

An orthodontic aligner tray includes a plurality of tooth-shaped cavities configured to adjust alignment or position of at least one tooth in the mouth of a patient. An apparatus to retain the orthodontic aligner tray to teeth of the patient includes the aligner tray including the plurality of tooth-shaped cavities, a retention feature located to the aligner tray between a first of the tooth-shaped cavities and a second of the tooth-shaped cavities adjacent to the first tooth shaped cavity, and an adhering agent connecting the aligner tray and the retention feature.

### TECHNICAL FIELD

This disclosure is related to removable orthodontic appliances including improved structure for retention to a patient's teeth.

### BACKGROUND

The statements in this section merely provide background information related to the present disclosure. Accordingly, such statements are not intended to constitute an admission of prior art.

An aligner tray is a dental device used by an orthodontic professional to adjust the alignment and/or positions of a patient's teeth. According to one exemplary embodiment, an aligner tray is a formed polymer with tooth shaped cavities which fits over all or most of either the upper or lower teeth of the patient. A pair of aligner trays can be used, one fitted to the upper teeth and a second fitted to the lower teeth. According to one exemplary embodiment, the aligner tray is made of a substantially transparent plastic approximately one to three millimeters thick.

An aligner tray is based upon the pre-existing alignment and position of the teeth of the patient. The tooth shaped cavities in the aligner tray include small alignment and/or position changes as compared to the pre-existing alignment and position of the teeth of the patient. According to one exemplary embodiment, a series of aligner trays can be used sequentially, each tray implementing incremental changes to tooth alignment and/or position.

A dental impression is a tool utilized by orthodontic professionals to model a patient's teeth. A dental impression can be made by fitting a first soft substance to the teeth of the patient, and then making a hardened dental impression of the teeth by using the first soft substance as a mold. In one exemplary embodiment, the dental impression can be made of plaster. An aligner tray can be made by pressure-forming a flat plastic blank over the dental impression. Pressure-forming, including using a positive pressure or a pressure greater than atmospheric pressure to press down upon a blank or using a vacuum or pressure less than atmospheric pressure to pull down upon a blank, is a technique known in the art and will not be discussed in detail herein. Pressure-forming will be used to disclose a manufacturing method herein, and it will be assumed throughout that either a positive pressure method or a vacuum method can be utilized. Pressure-forming the flat plastic blank over the dental impression results in an aligner tray being formed that fits perfectly to the dental impression. By modifying the dental impression, adjusting the teeth of the dental impression, the resulting aligner tray can include changes in alignment and/or position as compared to the teeth of the patient. According to one exemplary embodiment, a plurality of dental impressions can be formed based upon the teeth of the patient, and the orthodontic professional can remove from the dental impression the teeth that need to be adjusted. By using clay, wax, plaster, or a similar substance to relocate the removed teeth to the remainder of the impression, the orthodontic professional can model the desired changes to the patient's teeth and use the impression to create an aligner tray to create the desired effect.

Traditional orthodontic braces include wires running through appliances semi-permanently adhered to the surface of the teeth. Aligner trays have a beneficial feature as compared to traditional braces in that the aligner trays can be removed occasionally, for example, to permit the patient to eat without the aligner trays being present in the patient's mouth. However, the aligner trays must be retained properly to the teeth in order to correctly realign and/or reposition the teeth.

### SUMMARY

An orthodontic aligner tray includes a plurality of tooth-shaped cavities configured to adjust alignment or position of at least one tooth in the mouth of a patient. An apparatus to retain the orthodontic aligner tray to teeth of the patient includes the aligner tray including the plurality of tooth-shaped cavities, a retention feature located to the aligner tray between a first of the tooth-shaped cavities and a second of the tooth-shaped cavities adjacent to the first tooth shaped cavity, and an adhering agent connecting the aligner tray and the retention feature.

### BRIEF DESCRIPTION OF THE DRAWINGS

One or more embodiments will now be described, by way of example, with reference to the accompanying drawings, in which:

FIG. 1 illustrates an exemplary aligner tray including retention features, in accordance with the present disclosure;

FIG. 2 illustrates an exemplary aligner tray including retention features located to the teeth of a patient, in accordance with the present disclosure;

FIG. 3 illustrates an exemplary aligner tray, retention features, and an adhering agent locating the retention features to the aligner tray, in accordance with the present disclosure;

FIG. 4 illustrates in cross section an exemplary aligner tray, a C-shaped clip, and an adhering agent, in accordance with the present disclosure;

FIG. 5 illustrates an exemplary square retention clip, in accordance with the present disclosure;

FIG. 6 illustrates an exemplary retention clip with an extended closed end, in accordance with the present disclosure;

FIG. 7 illustrates an exemplary retention bracket aligned to a plurality spaces between teeth of a patient, in accordance with the present disclosure;

FIG. 8 illustrates an exemplary retention clip made of a polymer, in accordance with the present disclosure;

FIG. 9 illustrates exemplary retention features located to a dental impression including an adhering agent applied to the dental impression proximate to the retention features in preparation for a pressure-forming process, in accordance with the present disclosure;

FIG. 10 illustrates an aligner tray corresponding to an upper jaw of a patient, an aligner tray corresponding to a lower jaw of a patient, and elastic band retention features located to each of the aligner trays, in accordance with the present disclosure;

FIG. 11 illustrates an aligner tray including a retention bracket spanning both sides of the aligner tray, in accordance with the present disclosure;

FIG. 12 illustrates an aligner tray including a retention bracket spanning both sides of the aligner tray including central portion of the bracket with a wide arc configuration, in accordance with the present disclosure; and

FIG. 13 illustrates a piston device pushing upon the lower jaw in a forward direction, in accordance with the present disclosure.

### DETAILED DESCRIPTION

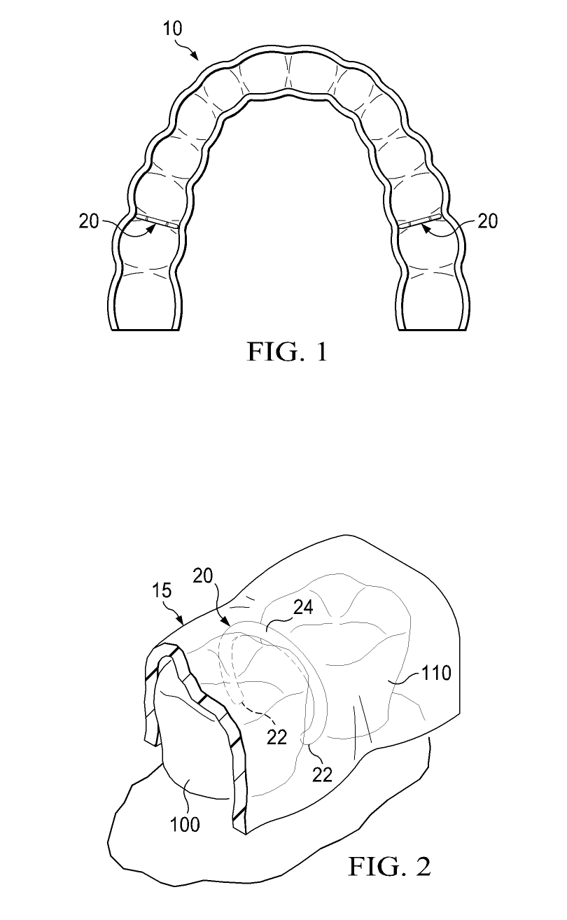

Referring now to the drawings, wherein the showings are for the purpose of illustrating certain exemplary embodiments only and not for the purpose of limiting the same, FIG. 1 illustrates an exemplary aligner tray including retention features. Aligner tray 10 is formed to the shape of one of a patient's top teeth or bottom teeth. Aligner tray 10 includes a series of tooth-shaped cavities configured to receive corresponding teeth of the patient. Aligner tray 10 includes at least one retention feature embodied as a retention clip 20 aligned to grasp the patient's teeth. A plurality of retention clips 20 can be used, aligned to a plurality of spaces between a patient's teeth. FIG. 1 illustrates an embodiment wherein two retention clips 20 are located symmetrically upon the aligner tray 10 or located at substantially identical locations on left and right sides of the aligner tray 10. In another embodiment, a different number of retention clips can be used in non-symmetrical locations upon the aligner tray. The retention clips 20 illustrated in FIG. 1 are each located between teeth toward the rear of the mouth. One having skill in the art would appreciate that the exemplary illustrated retention clips 20 are located between molars of the patient, however, retention clips can be used at various locations between different teeth and still be within the scope of the present disclosure. A location of a retention clip 20 can be equivalently described as being located between teeth of the patient and being located between tooth-shaped cavities on the aligner tray 10.

A retention feature can be made of a number of different materials, including a metal wire or a plastic or polymer material. A metal wire used as a retention feature can be made of a metal or an alloy including materials known in the art for use in a patient's mouth.

In one embodiment, retention clip 20 includes a C-shaped clip configured to fit between two of the tooth shaped cavities, such that when the aligner is placed upon the teeth of the patient, the C-shaped clip fits to the space between two of the patient's teeth, with the clip ends forming the open end of the C lightly contacting the two teeth forming the space near the bases of the teeth proximate to the patient's gums. The rest of the C-shaped is oriented to the space between the teeth, such that the closed end of the C extends above the crests of the teeth directly above the space between the teeth.

FIG. 2 illustrates an exemplary aligner tray including retention features located to the teeth of a patient. Section 15 of aligner tray 10 is illustrated including retention clip 20 placed upon patient's tooth 100 and tooth 110. Retention clip 20 includes two clip ends 22 which point inward and are configured to the geometry of the space between tooth 100 and tooth 110. Retention clip 20 is aligned to the space between tooth 100 and tooth 110, such that clip ends 22 lightly contact each of tooth 100 and tooth 110, providing a gripping force, retaining aligner tray 10 to the teeth of the patient. Closed end 24 of retention clip 20 extends above tooth 100 and tooth 110 and attaches to aligner tray 10.

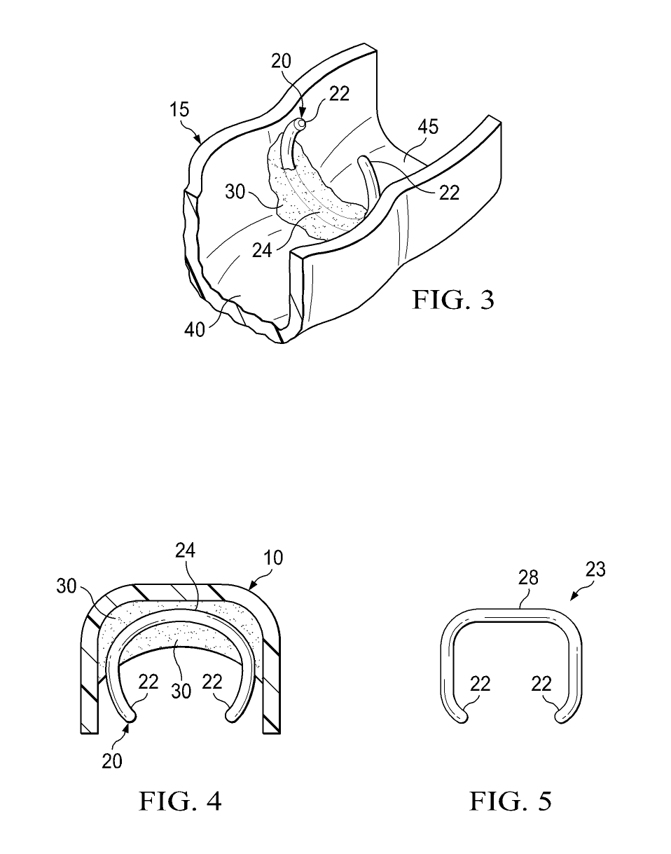

A retention feature needs to be attached to aligner tray 10. In one embodiment, wherein aligner tray 10 is manufactured from a liquid plastic material, such as in an injection molding process, the retention feature can be set within the aligner tray as the tray is created. In another embodiment, wherein aligner tray 10 is manufactured from a solid blank, such as in a pressure-forming process, an adhering agent can be used to attach the retention feature to aligner tray 10. FIG. 3 illustrates an exemplary aligner tray, retention features, and an adhering agent locating the retention features to the aligner tray. Section 15 of aligner tray 10 is illustrated including retention clip 20 located between a first tooth-shaped cavity 40 and a second tooth shaped cavity 45. Retention clip 20 is connected to tray 10 with adhering agent 30. Adhering agent 30 can include any adhesive known in the art for use in a patient's mouth. According to one embodiment, adhering agent 30 can be a binary acrylic adhesive. In another embodiment, adhering agent 30 can be a liquid cement known in the art. Retention clip 20 includes two clip ends 22 and closed end 24. Adhering agent 30 encapsulates closed end 24 and fixedly holds retention clip 20 in position relative to aligner tray 10. Adhering agent 30 is additionally connected to the inside surface of aligner tray 10. Closed end 24 must include sufficient clearance from the teeth of the patient to permit an adequate amount of adhering agent 30 to securely hold retention clip 20.

FIG. 4 illustrates in cross section an exemplary aligner tray, a C-shaped clip, and an adhering agent. Aligner tray 10 is illustrated including retention clip 20 and adhering agent 30. Retention clip 20 includes two clip ends 22 and closed end 24. Adhering agent 30 encapsulates closed end 24 and fixedly holds retention clip 20 in position relative to aligner tray 10.

Retention clip 20 can include a number of different shapes. Retention clip 20 can be a C-shaped clip as illustrated in FIG. 4. FIG. 5 illustrates an exemplary square retention clip. Retention clip 23 includes two clip ends 22 and a squared closed end 28. A number of shapes for retention clips are envisioned, and the disclosure is not intended to be limited to the particular exemplary embodiments provided herein.

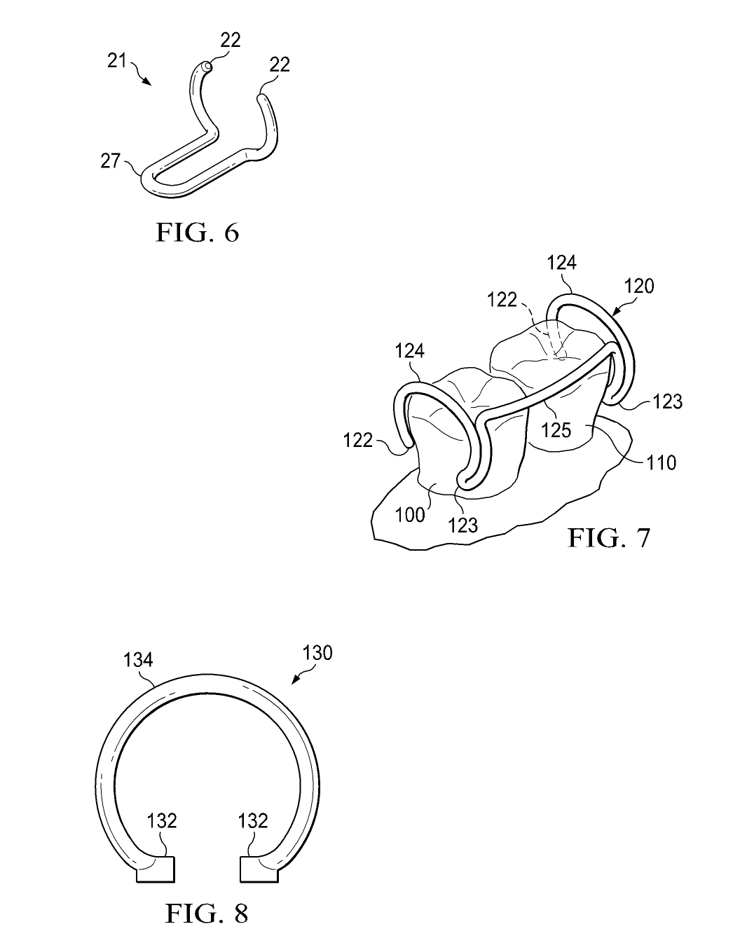

Retention clip 20 can include a closed end 24 which is encapsulated within adhering agent 30. Closed end 24 can include a complex shape to increase a length of the clip encapsulated within adhering agent 30, thereby increasing the durability of the attachment of retention clip 20 to aligner tray 10. FIG. 6 illustrates an exemplary retention clip with an extended closed end. Retention clip 21 includes two clip ends 22 and extended closed end 27. Clip ends 22 are oriented to be aligned to a space between two teeth of a patient. Extended closed end 27 projects in a perpendicular direction from the orientation of clip ends 22. Extended closed end 27 can be parallel to a flat section of aligner tray 10 and be partially or fully encapsulated by adhering agent 30. By encapsulating extended closed end 27, the attachment of retention clip 21 to aligner tray 10 can be achieved with increased durability. Further, extended closed end 27 can act as a spring member for retention clip 21, permitting clip ends 22 to flex, thereby gripping the teeth of the patient more effectively.

A retention feature can include a retention clip 20. In another exemplary embodiment, a retention feature can include a retention bracket aligned to a plurality of spaces between a patient's teeth. FIG. 7 illustrates an exemplary retention bracket aligned to a plurality spaces between teeth of a patient. Retention bracket 120 includes two clip ends 122, two bent clip ends 123, two closed ends 124, and a bracket arm 125. Retention bracket 120 is aligned to patient's tooth 100 and tooth 110. One of clip ends 122 and a corresponding one of bent clip ends 123 are aligned to a space between tooth 100 and an adjacent tooth next to tooth 100. A second of clip ends 122 and a corresponding second of bent clip ends 123 are aligned to a space between tooth 110 and a second adjacent tooth next to tooth 110. The two sets of clip ends 122 and bent clip ends 123 provide retention bracket 120 with retention details located to two spaces between teeth of the patient. Bracket arm 125 connects the two sides of retention bracket 120. One having skill in the art will appreciate that retention bracket 120 forms a rigid frame that can be configured to fit to and durably retain the shape of a plurality of spaces between teeth of a patient. Further, closed ends 124 and bracket arm 125 can all be encapsulated by an adhering agent 30 to provide an attachment to aligner tray 10 with increased durability. Retention bracket 120 can include a number of embodiments. FIG. 7 illustrates a retention bracket 120 including retention details between a tooth 100 and an adjacent tooth and details between a tooth 110 and another adjacent tooth. In another embodiment, retention bracket can include retention details between a first tooth and an adjacent second tooth, and additional details between the first tooth and another adjacent third tooth.

A retention bracket can be configured to attach to a number of teeth of the patient located in a series on one area of the patient's jaw. According to another embodiment, a retention bracket can span the mouth of the patient to locate to spaces between teeth of the patient on opposite sides of the jaw. In this way, a retention bracket can increase retention force to the teeth of the patient by gripping across the entire mouth of the patient. FIG. 11 illustrates an aligner tray including a retention bracket spanning both sides of the aligner tray. Configuration 300 includes aligner tray 310 including tooth-shaped cavities 312, 314, 316, and 318. Exemplary configuration 300 is configured to the upper jaw of a patient wherein top of the mouth does not include the structure of the tongue, and a central portion 324 of retention bracket 320 can curve upward in the mouth to stay along the top service of the mouth, but otherwise directly span the distance between the two sides of the mouth without having to avoid the patient's tongue. Retention bracket 320 is illustrated located on one side of aligner tray 310 to a space between tooth-shaped cavities 312 and 314, and retention bracket 320 is located on the other side of aligner tray 310 to a space between tooth-shaped cavities 316 and 318. Clip ends 322 are configured to grip to the teeth of the patient similarly to other clip ends disclosed herein. Central portion 324 of retention bracket 320 can include a spring member 330, adding flexibility to the bracket and providing improved retention force to the teeth of the patient.

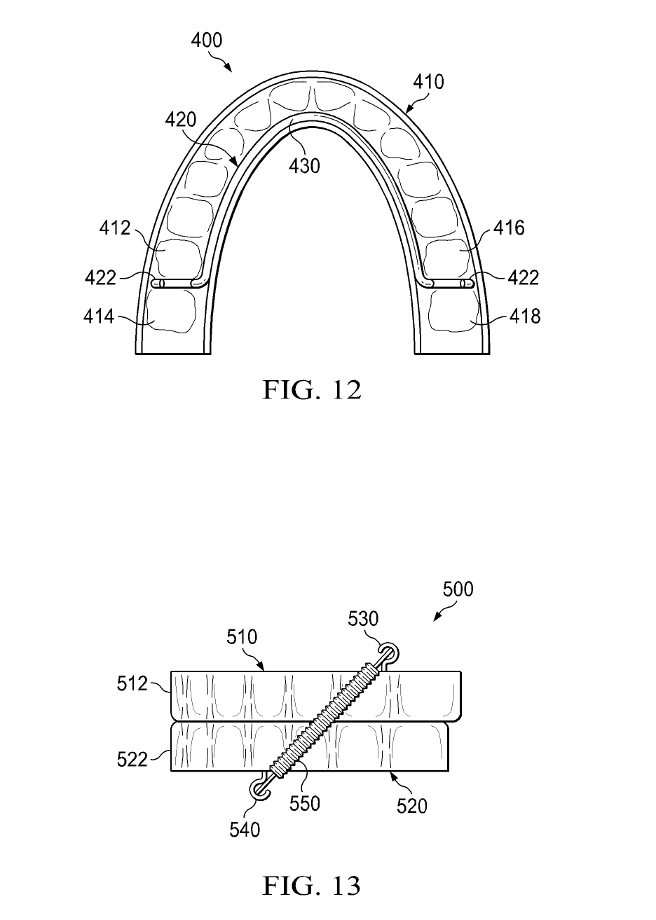

FIG. 12 illustrates an aligner tray including a retention bracket spanning both sides of the aligner tray including central portion of the bracket with a wide arc configuration. Configuration 400 includes aligner tray 410 including tooth-shaped cavities 412, 414, 416, and 418 and a retention bracket 420. Exemplary configuration 400 can be configured to either the upper jaw or lower jaw of a patient. A central portion 430 of retention bracket 420 can be configured to particular dental features of the mouth of the patient. The exemplary embodiment of central portion 430 includes a wide arc providing wide clearance of the central portion of the bracket from a center of the mouth of the patient, for example, merging the central portion 430 with an inner perimeter of aligner tray 410. A number of different embodiments for central portion 430 are envisioned according to different dental requirements. According to one embodiment, central portion 430 can be configured to avoid the tongue of the patient. In another embodiment, central portion 430 can be configured based upon orthodontic criteria known in the art. Retention bracket 420 is illustrated located on one side of aligner tray 410 to a space between tooth-shaped cavities 412 and 414, and retention bracket 420 is located on the other side of aligner tray 410 to a space between tooth-shaped cavities 416 and 418. Clip ends 422 are configured to grip to the teeth of the patient similarly to other clip ends disclosed herein. Central portion 430 of retention bracket 420 can provide a spring force to retention bracket 420, adding flexibility to the bracket and providing improved retention force to the teeth of the patient.

In one embodiment, a retention feature can be made of a metal wire. In another embodiment, a retention feature can be made of an alternative material, such as a polymer or a hard plastic material. FIG. 8 illustrates an exemplary retention clip made of a polymer. Retention clip 130 includes two clip ends 132 and a closed end 134. The polymer material for retention clip 130 can be selected from plastics and other similar materials known in the art for use in a patient's mouth. An exemplary retention clip 20 made from a single metal wire can include a single cross section of wire. Retention clip 130 can include any variety of cross sections, for example, adjusting an elasticity of different parts of retention clip 130, adding jagged or notched features to closed end 134 to increase gripping strength in the connection of retention feature 130 to adhering agent 30, or adjusting how clip ends 132 interact with the patient's teeth. A number of different cross sections can be selected for use in retention clip 130, and the disclosure is not intended to be limited to the particular exemplary embodiments provided herein.

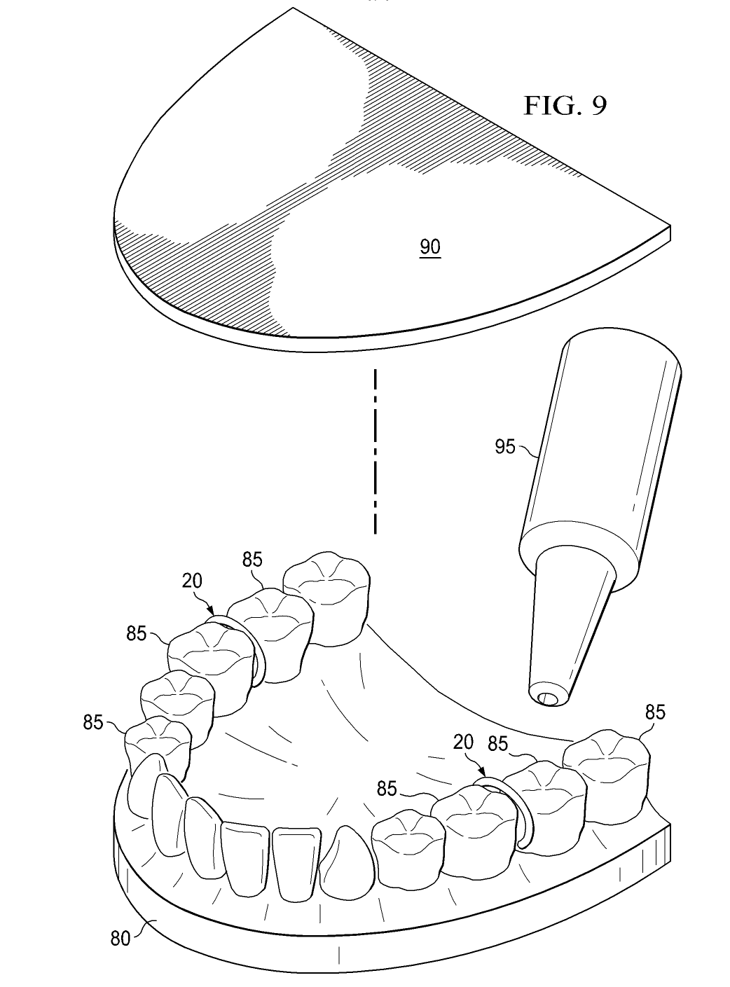

FIG. 9 illustrates exemplary retention features located to a dental impression including an adhering agent applied to the dental impression proximate to the retention features in preparation for a pressure-forming process. Dental impression 80 is a rigid physical model of a patient's teeth including a plurality of tooth features 85. Dental impression 80 is manufactured according to methods known in the art. In order to manufacture an aligner tray effective to adjust alignment and/or position of a patient's teeth, tooth features 85 can be adjusted based upon desired tooth adjustments. Dental impression 80 is located in a pressure-forming device known in the art which is configured to apply a pressure effective to form-fit a piece of polymer such as aligner tray blank 90 over a selected shape such as dental impression 80, such that a rigid plastic part is formed with cavities based upon features upon the selected shape. Using an aligner tray blank 90 to manufacture an aligner tray 10 using pressure-forming is known in the art. Retention clips 20 are each located to spaces between two tooth features 85. Retention clips 20 can be adjusted to a desired fit to the tooth features 85, adjusting size or width of the gap between the clip ends of the retention clips, according to methods known in the art. Adhering agent dispenser 95 is used to apply a measured amount of adhering agent to each of retention clip 20. An adhering agent can be selected that begins in a semi-liquid or paste form and sets to a solid over time. Additionally, an adhering agent can be selected that includes sufficient viscosity, such that being placed between dental impression 80 and aligner tray blank 90 during a pressure-forming process, the aligner tray blank 90 is formed around the adhering agent. Aligner tray blank 90 can be a thin, flat polymer sheet made of a material known in the art used in pressure-forming. In one embodiment, aligner tray blank 90 can be a clear polymer, such that the resulting aligner tray is a clear aligner tray. Aligner tray blank 90 is located to be placed over dental impression 80 and subsequently pressure formed to the dental impression 80 including the retention clips 20 and adhering agent. After the adhering agent sets, the resulting aligner tray 10 including connected retention clips 20 can be removed from the dental impression 80.

Orthodontic appliances are used for additional dental applications. For example, methods are known to use an elastic band or bands to remedy an alignment of the lower jaw of a patient to the upper jaw. Under certain circumstances, by applying a tensile force upon the lower jaw, an orthodontic appliance can encourage growth of the lower jaw in a forward direction, correcting a lower jaw that is too short for a proper alignment to the upper jaw. Similarly, compressive force on the lower jaw of a patient can discourage or slow growth in the lower jaw. Known methods to attach an elastic band to the teeth of the patient include bonding or permanently adhering an elastic band retention feature to a tooth upon the upper jaw and another elastic band retention feature to a tooth on the lower jaw.

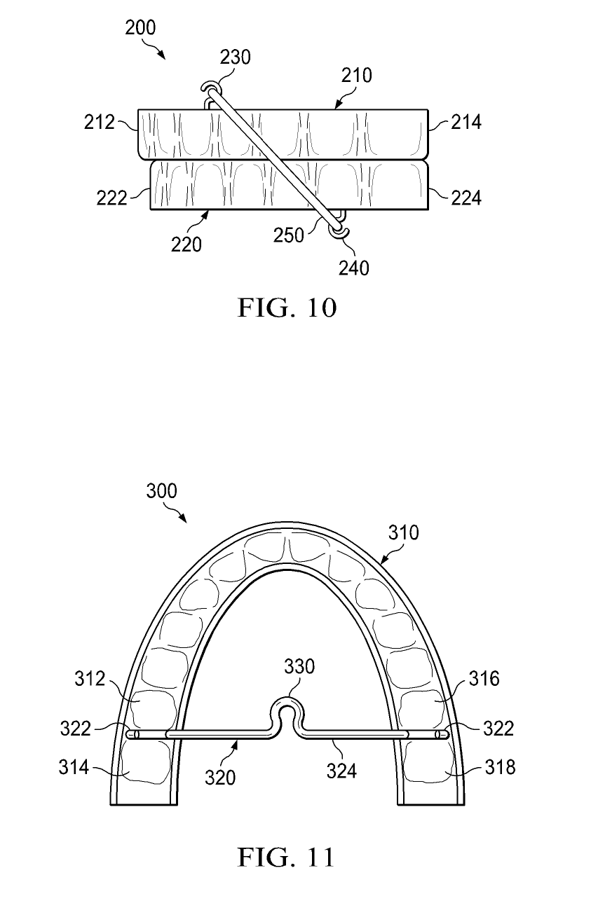

Known aligner tray configurations cannot utilize band retention features. The force applied by the elastic bands would act to dislodge one or both of the aligner trays from the teeth of the patient. However, with the retention features disclosed herein, sufficient retention force to the teeth of the patient can be achieved, such that elastic band retention features can be located to the aligner trays. FIG. 10 illustrates an aligner tray corresponding to an upper jaw of a patient, an aligner tray corresponding to a lower jaw of a patient, and elastic band retention features located to each of the aligner trays. Configuration 200 is illustrated including upper aligner tray 210, including a front 212 of the tray and a rear 214 of the tray. Lower aligner tray 220 is illustrated, including a front 222 of the tray and a rear 224 of the tray. Each of the upper tray 210 and the lower tray 220 include retention features according to one of the embodiments of the disclosure. According to one embodiment, a retention bracket such as is illustrated in FIG. 7 can be utilized to maximize a retention force to the teeth. Upper tray 210 includes an elastic band retention feature 230, and lower tray 220 includes an elastic band retention feature 240. Elastic band 250 is illustrated spanning the distance between elastic band retention features 230 and 240. Each of exemplary elastic band retention features 230 and 240 include small curved hooks with open ends pointing away from the elastic band 250. Each of elastic band retention feature 230 and elastic band retention feature 240 can be an extension of a retention feature adhered to the aligner tray. For example, retention clip 21 of FIG. 6 can include one of the clip ends 22 modified and extended to form an elastic band retention feature. Similarly, the retention bracket 120 of FIG. 7 can include one of the clip ends 22 modified and extended to form an elastic band retention feature. Each aligner tray can include an elastic band retention feature on each side of the aligner tray, such that an elastic band can be attached to the elastic band retention features on each the left and right side of the mouth of the patient. A number of retention features with an elastic band retention feature located thereto are envisioned, and the disclosure is not intended to be limited to the particular exemplary embodiments provided herein. FIG. 10 illustrates elastic band retention features and elastic bands configured to pull forward on the jaw. Depending upon the desired orthodontic effect, the configuration can be reversed to pull backward on the lower jaw. Further, a required location for a retention feature upon the aligner tray, for example, based upon the particulars of a patient's teeth, can be different from the location required for the elastic band retention feature to create the desired force upon the jaws of the patient. In such a circumstance, an elastic band retention feature can be adhered to the aligner tray according to methods disclosed herein at a separate location from the retention features located to the tray.

FIG. 10 illustrates elastic bands applying a force upon the lower jaw by pulling upon the jaw. FIG. 13 illustrates a piston device pushing upon the lower jaw in a forward direction. Configuration 500 is illustrated including upper aligner tray 510, including a front 512 of the tray and a rear 514 of the tray. Lower aligner tray 520 is illustrated, including a front 522 of the tray and a rear 524 of the tray. Each of the upper tray 510 and the lower tray 520 include retention features according to one of the embodiments of the disclosure. According to one embodiment, a retention bracket such as is illustrated in FIG. 7 can be utilized to maximize a retention force to the teeth. Upper tray 510 includes a piston retention feature 330, and lower tray 520 includes a piston retention feature 540. Piston device 550 is illustrated spanning the distance between piston retention features 530 and 540. Each of exemplary piston retention features 530 and 540 include small curved hooks with open ends pointing toward the piston 550. Each of piston retention feature 530 and piston retention feature 540 can be an extension of a retention feature adhered to the aligner tray. A plurality of piston devices can be used at different locations, such as opposite sides of the mouth, and the configuration can be reversed such that the piston creates a force upon the lower jaw in a rearward direction.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Apparatus to retain an orthodontic aligner tray to teeth of a patient, the apparatus comprising:
the aligner tray comprising a plurality of tooth-shaped cavities;
a retention feature located to the aligner tray between a first of the tooth-shaped cavities and a second of the tooth-shaped cavities adjacent to the first tooth shaped cavity; and
an adhering agent connecting the aligner tray and the retention feature.

2. The apparatus of claim 1, wherein the adhering agent comprises a binary acrylic adhesive.

3. The apparatus of claim 1, wherein the retention feature comprises a retention clip.

4. The apparatus of claim 3, wherein the retention clip comprises a C-shaped clip.

5. The apparatus of claim 4, further comprising a second retention clip comprising a second C-shaped clip; and
a second adhering agent connecting the aligner tray and the second C-shaped clip.

6. The apparatus of claim 5, wherein the retention clips are located symmetrically upon the aligner tray.

7. The apparatus of claim 3, wherein the retention clip comprises an extended closed end projecting from the retention clip in a perpendicular direction.

8. The apparatus of claim 3, wherein the retention clip comprises a polymer retention clip.

9. The apparatus of claim 1, wherein the retention feature comprises a retention bracket, wherein the retention bracket comprises four retention details located to two spaces between tooth-shaped cavities.

10. The apparatus of claim 1, wherein the retention feature comprises a retention bracket, wherein the retention bracket spans from a first side of the aligner tray to a second side of the tray.

11. The apparatus of claim 10, wherein the retention bracket comprises a central portion with a spring member.

12. The apparatus of claim 1, wherein the aligner tray comprises a first aligner tray comprising a first elastic band retention feature; and
further comprising a second aligner tray comprising a second elastic band retention feature.

13. The apparatus of claim 12, wherein the first elastic band retention feature and the second elastic band retention feature are located to a left side of the mouth;
wherein the first aligner tray further comprises a third elastic band retention feature on the right side of the first aligner tray; and
wherein the second aligner tray further comprises a fourth elastic band retention feature on the right side of the second aligner tray.

14. The apparatus of claim 13, further comprising:
a first elastic band located to the first elastic band retention feature and second elastic band retention feature; and
a second elastic band located to the third elastic band retention feature and the fourth elastic band retention feature.

15. The apparatus of claim 1, wherein the aligner tray comprises a first aligner tray comprising a first piston retention feature; and
further comprising a second aligner tray comprising a second piston retention feature.

16. The apparatus of claim 15, wherein the first piston retention feature and the second piston retention feature are located to a left side of the mouth;
wherein the first aligner tray further comprises a third piston retention feature on the right side of the first aligner tray; and
wherein the second aligner tray further comprises a fourth piston retention feature on the right side of the second aligner tray.

17. The apparatus of claim 16, further comprising:
a first piston device located to the first piston retention feature and second piston retention feature; and
a second piston device located to the third piston retention feature and the fourth piston retention feature.

18. Apparatus to retain a pressure-formed orthodontic aligner tray to teeth of a patient, the apparatus comprising:
the aligner tray configured to adjust alignments and positions of the teeth of the patient;
a first retention clip located to the aligner tray between a first of the teeth of the patient and a second of the teeth of the patient;
a second retention clip located to the aligner tray between a third of the teeth of the patient and a fourth of the teeth of the patient;
a first adhering agent encapsulating a closed end of the first retention clip and adhering the first retention clip to the aligner tray; and
a second adhering agent encapsulating a closed end of the second retention clip and adhering the second retention clip to the aligner tray.

19. The apparatus of claim 18, wherein the retention clips comprise metal wire clips.

20. A method to manufacture an orthodontic aligner tray comprising retention features, the method comprising:
creating a dental impression of teeth of the patient comprising tooth features;
locating a plurality of the retention features to the dental impression;
applying an adhering agent to each of the retention features; and
pressure-forming an aligner tray blank over the dental impression, retention features, and adhering agent to create the aligner tray, wherein the aligner tray blank comprises a thin, flat polymer sheet.
